(19) United States
(12) Patent Application Publication
(10) Pub. No.: US 2026/0050571 A1
(43) Pub. Date: Feb. 19, 2026

(54) QUANTIZATION PREDICTION FOR BLOCK DATA

(71) Applicants: ADVANCED MICRO DEVICES, INC., Santa Clara, CA (US); XILINX, INC., San Jose, CA (US)

(72) Inventors: Alireza Khodamoradi, Lafayette, CO (US); Adam H. Li, Solana Beach, CA (US); Eric Ford Dellinger, Longmont, CO (US); Francisco Barat Quesada, Leuven (BE); Kristof Denolf, Longmont, CO (US); Luc De Coster, Antwerp (BE); Philip B. James-Roxby, Longmont, CO (US); Ralph Wittig, Menlo Park, CA (US)

(21) Appl. No.: 18/804,214

(22) Filed: Aug. 14, 2024

(51) Int. Cl. G06F 15/80

(52) U.S. Cl. CPC G06F 15/8092

(57) ABSTRACT

A scalar processor associated with a vector processor reduces the quantization error for blocked data with a relatively small register size by predicting adjustments for shared scalars used in runtime quantization. The scalar processor provides a recommended scale value to the vector processor for scaling a block of data from a wide data type format to a narrow data type format. The scalar processor and the vector processor share a register at which the scalar processor stores the recommended scale value and from which the vector processor accesses the recommended scale value. The vector processor performs an operation to quantize at least a portion of the block of data by applying a scale value that is based on the recommended scale value.

### BACKGROUND

Vector processors implement an instruction set that allows them to operate efficiently on vectors, which are large one-dimensional arrays of data commonly used in machine learning and artificial intelligence applications. As neural networks have increased in size, new block-scaled data types have been proposed that share a scalar (also referred to as a scale) for a block of numbers. For high-precision data types, storing the required full-precision numbers in near-processor memory becomes costly or impossible. It is also costly to execute operations such as multiplication on higher-precision numbers. Quantization methods can be used to reduce the bit-width of data to reduce the required storage and other computational costs such as multiplication and addition.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a scalar processor to provide a recommended scale for scaling block data to a vector processor in accordance with some embodiments.

FIG. 2 is a block diagram of a scalar processor providing a recommended scale for scaling a block of data to a vector processor via a shared register in accordance with some embodiments.

FIG. 3 is a block diagram of a scalar processor receiving feedback regarding a portion of a block of data from a first vector processor and providing an updated recommended scale value for quantizing additional portions of the block of data based on the feedback in accordance with some embodiments.

FIG. 4 is a block diagram of a scalar processor receiving feedback regarding multiple portions of a block of data from multiple vector processors and providing an updated scale recommendation to the vector processors based on the feedback in accordance with some embodiments.

FIG. 5 is a flow diagram illustrating a method for providing a recommended scale for scaling block data from a scalar processor to a vector processor in accordance with some embodiments.

### DETAILED DESCRIPTION

Quantization techniques are used to convert higher-precision data types to narrower number formats, including the block-scaled data formats that allow for high performance vectorized operations on many hardware platforms. Quantizing for block-scaled data formats involves applying a shared scale to a block of numbers (e.g., multiplying each of the numbers by a shared scalar, such as the highest number of the block). To reduce the quantization error, an entire block of full-precision numbers has to be checked to calculate an appropriate shared scalar for quantizing the block. For example, if the block size is 256, a register file having 256× full-precision-bit storage space is needed to determine an appropriate scalar with which to quantize the block with low quantization error.

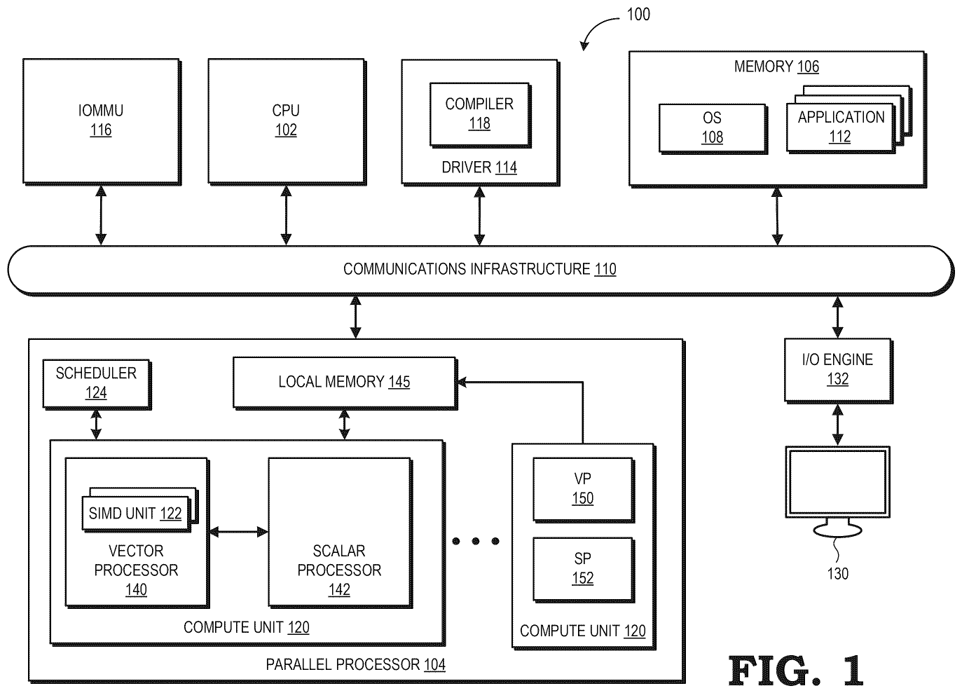

FIGS. 1-5 illustrate techniques for reducing the quantization error for blocked-scaled data with a relatively small register size by using a scalar processor that is associated with a vector processor to predict adjustments for shared scalars used in quantization. In some implementations, the scalar processor and the vector processor are included in a single compute unit (i.e., the scalar processor and the vector processor are “local” to each other), allowing the scalar processor to assist the vector processor with runtime quantization. Further, the proximity of the on-chip scalar processor to the vector processor provides high bandwidth between the two processors that allows for fast updates to the predicted adjustments, which in turn allows for more accurate quantization results. In some implementations, the scalar processor provides a recommended scale value to the vector processor for scaling a block of data from a wide data type format to a narrow data type format. The scalar processor and the vector processor share a register in some implementations at which the scalar processor stores the recommended scale value and from which the vector processor accesses the recommended scale value.

In some embodiments, the vector processor applies a scale value that is based on the recommended scale value to at least a portion of the block of data. Thus, in some cases the vector processor applies the recommended scale value and in other instances the vector processor considers the recommended scale value among other factors in selecting a scale value to apply to the block of data.

The vector processor and the scalar processor also share a feedback register in some embodiments that is accessible by both the vector processor and the scalar processor. The vector processor stores a characteristic value of at least a portion of the block of data at the shared feedback register for consideration by the scalar processor in recommending an updated scale value. For example, in some implementations, the characteristic value is an absolute maximum value of the numbers comprising the block of data. In other implementations, the characteristic value is the second highest value of the numbers comprising the block of data or some other metric of the numbers such as a median value. The scalar processor accesses characteristic value from the shared feedback register and uses the characteristic value to update the recommended scale value.

In some implementations, the block of data exceeds the size of the vector processor's register file and is divided into portions for quantization at more than one vector processor or at a single vector processor in multiple stages. In cases where quantization for the block of data is performed at multiple vector processors, each of the vector processors provides feedback concerning its respective portion of the block of data to the scalar processor, which updates the recommended scale value based on the feedback and provides the updated recommended scale value to each of the vector processors. The vector processor that is local to the scalar processor accesses the updated recommended scale value from the shared register and the non-local vector processor(s) access the updated recommended scale value from the local memory. Each of the vector processors then scale their respective portions of the block of data using a shared scale that is based on the updated recommended scale value.

In cases where quantization of the block of data is performed by a single vector processor over multiple stages, the vector processor provides a characteristic value of a first portion of the block of data to the scalar processor via the shared feedback register, and the scalar processor updates the recommended scale value based on the characteristic value. The scalar processor then provides the updated recommended scale value to the vector processor via the shared register and the vector processor scales the first portion of the block of data and any subsequent portions of the block of data based on the updated recommended scale value. In some implementations, the scalar processor provides an updated recommended scale value to the vector processor(s) for each output (i.e., for each block of data).

In some implementations, the scalar processor calculates or predicts additional information other than a shared scale for quantization. For example, in some implementations, the scalar processor provides the vector processor with a recommendation for pruning an output of an operation on the block of data. Thus, if the output, or activation, of an operation performed by the vector processor on the block of data is very small (i.e., close to zero), the scalar processor provides a recommendation to the vector processor via the shared register to prune the output of the operation.

The techniques described herein are, in different embodiments, employed at any of a variety of parallel processors (e.g., accelerated processing units (APUs), vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of a processing system 100 including a central processing unit (CPU) 102 and a parallel processor 104, in accordance with some embodiments. In at least some embodiments, the processing system 100 is a computer, laptop/notebook, mobile device, gaming device, wearable computing device, server, or any of various other types of computing systems or devices. It is noted that the number of components of the processing system 100 varies from embodiment to embodiment. In at least some embodiments, there is more or fewer of each component/subcomponent than the number shown in FIG. 1. It is also noted that the processing system 100, in at least some embodiments, includes other components not shown in FIG. 1. Additionally, in other embodiments, the processing system 100 is structured in other ways than shown in FIG. 1.

The parallel processor 104 includes a plurality of compute units (CU) 120 that execute instructions concurrently or in parallel. In some embodiments, each one of the CUs 120 includes one or more single instruction, multiple data (SIMD) units, and the CUs 120 are aggregated into workgroup processors, shader arrays, shader engines, or the like. The number of CUs 120 implemented in the parallel processor 104 is a matter of design choice and some embodiments of the parallel processor 104 include more or fewer compute units than shown in FIG. 1. In some embodiments, the parallel processor 104 is used for general purpose computing. In various embodiments, the parallel processor 104 includes any cooperating collection of hardware and or software that perform functions and computations associated with accelerating graphics processing tasks, data-parallel tasks, nested data-parallel tasks in an accelerated manner with respect to resources such as conventional central processing units (CPUs), conventional graphics processing units (GPUs), and combinations thereof.

As illustrated in FIG. 1, the processing system 100 also includes a system memory referred to herein as global memory 106, an operating system 108, a communications infrastructure 110, and one or more applications 112. Access to the global memory 106 is managed by a memory controller (not shown) coupled to global memory 106. For example, requests from the CPU 102 or other devices for reading from or for writing to the global memory 106 are managed by the memory controller. In some embodiments, the one or more applications include various programs or commands to perform computations that are also executed at the CPU 102. The CPU 102 sends selected commands for processing at the parallel processor 104. The parallel processor 104 executes instructions such as program code of one or more applications 112 stored in the global memory 106 and the parallel processor 104 stores information in the global memory 106 such as the results of the executed instructions.

The operating system 108 and the communications infrastructure 110 are discussed in greater detail below. The processing system 100 further includes a driver 114 and a memory management unit, such as an input/output memory management unit (IOMMU) 116. Components of the processing system 100 are implemented as hardware, firmware, software, or any combination thereof. In some embodiments, the processing system 100 includes one or more software, hardware, and firmware components in addition to or different from those shown in FIG. 1.

Within the processing system 100, the global memory 106 includes non-persistent memory, such as DRAM (not shown). In various embodiments, the global memory 106 stores processing logic instructions, constant values, variable values during execution of portions of applications or other processing logic, or other desired information. For example, in various embodiments, parts of control logic to perform one or more operations on the CPU 102 reside within the global memory 106 during execution of the respective portions of the operation by the CPU 102. During execution, respective applications, operating system functions, processing logic commands, and system software reside in the global memory 106. Control logic commands that are fundamental to the operating system 108 generally reside in the global memory 106 during execution. In some embodiments, other software commands (e.g., a set of instructions or commands used to implement the device driver 114) also reside in the global memory 106 during execution by the processing system 100.

The IOMMU 116 is a multi-context memory management unit. As used herein, context is considered the environment within which kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 116 includes logic to perform virtual to physical address translation for memory page access for devices, such as the parallel processor 104. In some embodiments, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in the global memory 106.

In various embodiments, the communications infrastructure 110 interconnects the components of the processing system 100. The communications infrastructure 110 includes (not shown) one or more of a peripheral component interconnect (PCI) bus, extended PCI (PCI-e) bus, advanced microcontroller bus architecture (AMBA) bus, advanced graphics port (AGP), or other such communication infrastructure and interconnects. In some embodiments, the communications infrastructure 110 also includes an Ethernet network or any other suitable physical communications infrastructure that satisfies an application's data transfer rate requirements. The communications infrastructure 110 also includes the functionality to interconnect components, including components of the processing system 100.

A driver 114 communicates with a device (e.g., parallel processor 104) through an interconnect or the communications infrastructure 110. When a calling program invokes a routine in the driver 114, the driver 114 issues commands to the device. Once the device sends data back to the driver 114, the driver 114 invokes routines in an original calling program. In general, drivers are hardware-dependent and operating-system-specific to provide interrupt handling required for any necessary asynchronous time-dependent hardware interface. In some embodiments, a compiler 118 is embedded within the driver 114. The compiler 118 compiles source code into program instructions as needed for execution by the processing system 100. During such compilation, the compiler 118 applies transforms to program instructions at various phases of compilation. In other embodiments, the compiler 118 is a standalone application. In various embodiments, the driver 114 controls operation of the parallel processor 104 by, for example, providing an application programming interface (API) to software (e.g., applications) executing at the CPU 102 to access various functionality of the parallel processor 104.

The CPU 102, in at least some embodiments, includes one or more single-or multi-core CPUs. The CPU 102 includes (not shown) one or more of a control processor, field-programmable gate array (FPGA), application-specific integrated circuit (ASIC), or digital signal processor (DSP). The CPU 102 executes at least a portion of the control logic that controls the operation of the processing system 100. For example, in various embodiments, the CPU 102 executes the operating system 108, the one or more applications 112, and the driver 114. In some embodiments, the CPU 102 initiates and controls the execution of the one or more applications 112 by distributing the processing associated with one or more applications across the CPU 102 and other processing resources, such as the parallel processor 104.

The parallel processor 104 executes commands and programs for selected functions, such as vector processing operations and other operations that are particularly suited for parallel processing. In general, the parallel processor 104 is frequently used for executing graphics pipeline operations, such as pixel operations, geometric computations, and rendering an image to a display. In some embodiments, the parallel processor 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the parallel processor 104.

The SIMD execution model is one in which multiple processing elements share a single program control flow unit and program counter and thus execute the same program but are able to execute that program with different data. The number of compute units 120 implemented in the parallel processor 104 is configurable. Each compute unit 120 includes one or more processing elements such as scalar and or vector floating-point units (referred to herein as scalar processors and vector processors, respectively), arithmetic and logic units (ALUs), and the like. In various embodiments, the compute units 120 also include special-purpose processing units (not shown), such as inverse-square root units and sine/cosine units.

Each of the one or more compute units 120 executes a respective instantiation of a particular work item to process incoming data, where the basic unit of execution in the one or more compute units 120 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a compute unit 120.

The parallel processor 104 issues and executes work-items, such as groups of threads executed simultaneously as a “wave”, on a single SIMD unit 122. Waves, in at least some embodiments, are interchangeably referred to as wavefronts, warps, vectors, or threads. In some embodiments, waves include instances of parallel execution of a shader program, where each wave includes multiple work items that execute simultaneously on a single SIMD unit 122 in line with the SIMD paradigm (e.g., one instruction control unit executing the same stream of instructions with multiple data). A scheduler 124 is configured to perform operations related to scheduling various waves on different CUs 120 and SIMD units 122 and performing other operations to orchestrate various tasks on the parallel processor 104.

To reduce latency associated with off-chip memory access, various parallel processor architectures include a local memory 145 implemented as, e.g., a memory cache hierarchy including, for example, L1 cache and a local data share (LDS). The LDS is a high-speed, low-latency memory private to each compute unit 120. In some embodiments, the LDS is a full gather/scatter model so that a workgroup writes anywhere in an allocated space.

In some embodiments, the processing system 100 includes input/output (I/O) engine 132 that includes circuitry to handle input or output operations associated with display 130, as well as other elements of the processing system 100 such as keyboards, mice, printers, external disks, and the like. The I/O engine 132 is coupled to the communications infrastructure 110 so that the I/O engine 132 communicates with the global memory 106, the parallel processor 104, and the CPU 102. In some embodiments, the CPU 102 issues one or more draw calls or other commands to the parallel processor 104. In response to the commands, the parallel processor 104 schedules, via the scheduler 124, one or more operations at the compute units 120. In some embodiments, based on the operations, the parallel processor 104 generates a rendered frame, and provides the rendered frame to the display 130 via the I/O engine 132.

The parallelism afforded by the one or more compute units 120 is suitable for general purpose compute and tensor operations. The scheduler 124 issues work to the compute units 120 to perform general purpose computation tasks, such as operations to accelerate the calculation of tensor operations, for execution in parallel. Some parallel computation operations require that the same command stream or compute kernel be performed on streams or collections of input data elements. Respective instantiations of the same compute kernel are executed concurrently on multiple SIMD units 122 in the one or more compute units 120 to process such data elements in parallel. As referred to herein, for example, a compute kernel is a function containing instructions declared in a program and executed on parallel processor compute unit 120.

In some embodiments, each compute unit 120 includes both a scalar processor 142, 152 and a vector processor 140, 150, allowing for versatile processing capabilities such as handling both single data elements at the scalar processor and arrays of data elements at the vector processor within a single compute unit 120. The scalar processors 142, 152 are configured to perform scalar arithmetic, including signed and unsigned multiplication, add/subtract, shifts, compares, and logical operations, elementary functions, such as square-root, sine/cosine, and the like. The vector processors 140, 150 are configured to perform vector arithmetic, including permute functions, pre-addition functions, multiplication functions, post-addition functions, accumulation functions, shift, round and saturate functions, upshift functions, and the like. The vector processors 140, 150 support multiple precisions for complex and real operands. The vector processors 140, 150 can include both fixed-point and floating-point data paths.

To facilitate more accurate quantization of blocks of data using smaller register files, the scalar processors 142, 152 provide recommendations for shared scale values to the vector processors 140, 150. In the illustrated example, the vector processor 140 and the scalar processor 142 are part of the same compute unit 120. As such, the scalar processor 142 assists the vector processor 140 with quantizing blocks of data by recommending a shared scale (i.e., a scale value recommended to be applied to all portions of a block of data) for a given block of data. The vector processor 140, in turn, provides feedback to the scalar processor 142 regarding characteristics of at least a portion of the block of data.

For example, if a portion of a block of data fits within the accumulator register file of the vector processor 140, the vector processor 140 analyzes the portion of the block of data and provides the scalar processor 142 a characteristic value of the portion of the block of data, such as an absolute maximum of the numbers comprising the portion of the block of data. The scalar processor 142 uses the characteristic value to update the recommended scale value for quantizing the block of data and provides the updated recommended scale value to the vector processor 140. In some embodiments, the scalar processor 142 provides the recommended scale value and the updated recommended scale value to the vector processor 140 via a shared register (not shown). The vector processor 140 provides the characteristic value to the scalar processor 142 via a shared feedback register in some embodiments.

If the size of a block of data exceeds the capacity of the accumulator register file of the vector processor 140, quantization of the block of data may be distributed among multiple vector processors. For example, vector processor 140 may quantize a first portion of the block of data and the vector processor 150 may quantize the second portion of the block of data. Whereas the scalar processor 142 is local to the vector processor 140, in that they are included in a single compute unit 120 and share a register, the scalar processor 142 is not local to the vector processor 150. Thus, the scalar processor 142 provides the recommended scale value and any updated recommended scale value to the non-local vector processor 150 via the local memory 145, which is accessible by both the scalar processor 142 and the vector processor 150. Similarly, the vector processor 150 provides feedback such as a characteristic value of its respective portion of the block of data to the scalar processor 142 via the local memory 145.

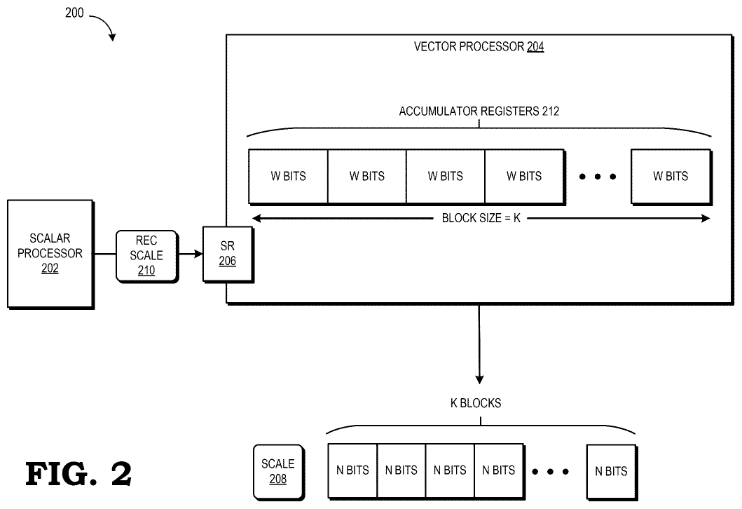

FIG. 2 is a block diagram 200 of a scalar processor 202 providing a recommended scale 210 for quantizing a block of data to a vector processor 204 via a shared register 206 in accordance with some embodiments. The block of data V includes K values (v₀, v₁, . . . , vₖ₋₁) , each of which is w bits wide. In the illustrated example, the block of K values is encoded in a wide data type format (e.g., fp32), such that the size of the block of data is (K×w) bits. The vector processor 204 includes a number A of accumulator registers 212, such that K is limited to K≤A.

Quantizing the block of data involves selecting a shared scale having r bits which is based on a characteristic of the block of data such as an absolute maximum value of the K values (e.g., the shared scale may be |max|). The scalar processor 202 calculates a recommended scale value 210 and provides the recommended scale value 210 to the vector processor 204 to use in selecting a shared scale 208 for the block of data. In the illustrated example, the scalar processor 202 stores the recommended scale value 210 at a shared register 206 that is accessible by both the scalar processor 202 and the vector processor 204. In some embodiments, the vector processor 204 uses the recommended scale value 210 as the shared scale 208, and in other embodiments, the vector processor 204 considers the recommended scale value 210 among other factors in determining the shared scale 208.

The shared scale 208 is applied to each of the K values, which are then scaled and rounded to a block of K values that are encoded in a narrow data type format (e.g., fp4) with the shared scale, such that each of the values is n bits wide. The block of K values that are encoded in the narrow data type format with the shared scale are stored at the local memory 145 in some implementations. Thus, the size of the quantized block of data is (K×n+r) bits, which is smaller than (K×w) bits. The smaller size of the quantized block of data allows the quantized block of data to fit within a smaller memory, which in turn makes operations such as addition and multiplication less computationally expensive. The shared scale more accurately quantizes the block of data, minimizing any quantization data loss.

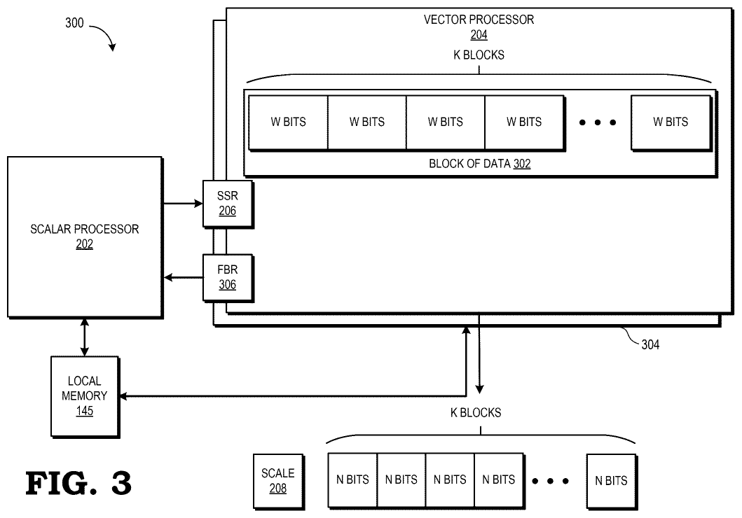

FIG. 3 is a block diagram 300 of the scalar processor 202 receiving feedback regarding a recommended scale value from a vector processor 204 to adjust the recommended scale for a block of data 302 in accordance with some embodiments. In the illustrated example, the block of data 302 exceeds the capacity of the accumulator registers 212 of the vector processor 204, and is therefore divided into multiple portions that are either stored successively at the accumulator registers 212 of the vector processor 204 over multiple stages or stored at multiple vector processors. For example, in some implementations, the block of data 302 is divided into multiple portions, one of which is stored at the accumulator registers 212 of the vector processor 204 and the other(s) of which are stored at the accumulator registers (not shown) of a second vector processor 304 and, in some embodiments, at one or more additional vector processors.

In some implementations, the scalar processor 202 provides a recommended scale value (not shown) to the vector processor 204 via the shared scale register 206. The vector processor 204 provides feedback to the scalar processor 202 based on the first portion of the block of data 302 that is stored at the accumulator registers 212 of the vector processor 204. In the illustrated example, the vector processor 204 provides the feedback via a feedback register 306 that is accessible by both the vector processor 204 and the scalar processor 202. The scalar processor 202 adjusts the recommended scale value based on the feedback to calculate an updated recommended scale value (not shown). In embodiments in which the other portion of the block of data 302 is stored in successive stages at the vector processor 204, the scalar processor 202 provides the updated recommended scale value to the vector processor 204 by storing the updated recommended scale value at the shared scale register 206. The vector processor 204 then uses the updated recommended scale value to determine a shared scale 208 that is applied to all portions of the block of data 302.

In implementations in which the other portion of the block of data 302 is stored in accumulator registers of the second vector processor 304, the scalar processor 202 provides the updated recommended scale value to the second vector processor 304 by storing the updated recommended scale value at the local memory 145. The second vector processor 304 accesses the updated recommended scale value from the local memory 145 and uses the updated recommended scale value to determine the shared scale 208 and apply it to the other portion of the block of data 302.

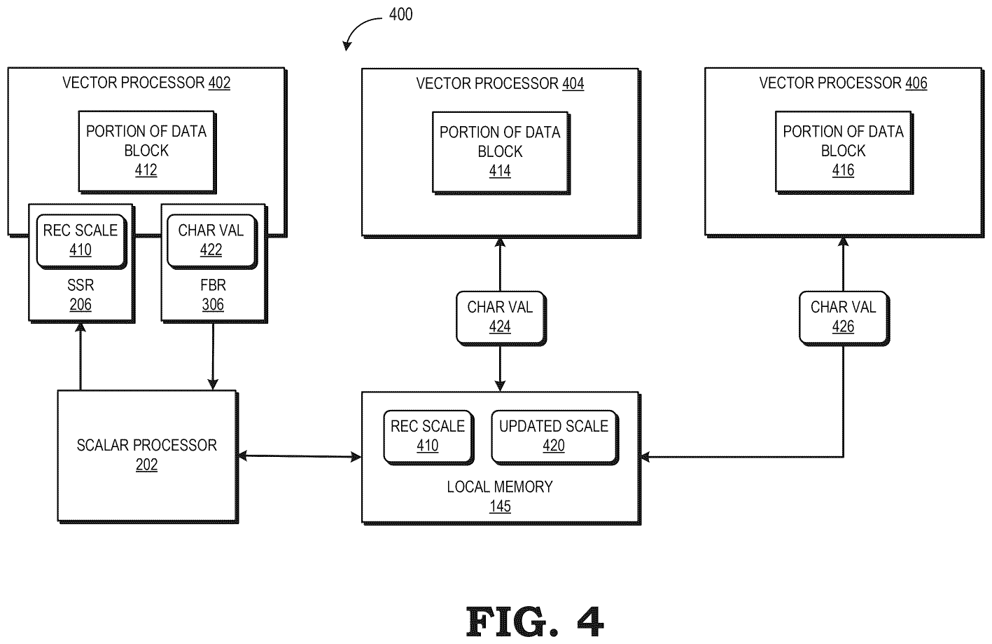

In some cases, the size of the block of data far exceeds the storage space available at any one vector processor. For example, if the block size is 256, 256× full-precision-bit storage space is needed to quantize the block. Using the scalar processor 202, the block of data can be divided into multiple portions (e.g., 8×32) while maintaining a low quantization error. FIG. 4 is a block diagram 400 of the scalar processor 202 receiving feedback regarding a recommended scale value 410 from a first vector processor 402 for a first portion 412 of a block of data, from a second vector processor 404 for a second portion 414 of the block of data, and from a third vector processor 416 for a third portion 416 of the block of data. The scalar processor 202 updates the recommended scale value based on the feedback and provides an updated scale recommendation 420 to each of the vector processors 402, 404, 406 for quantizing their respective portions of the block of data in accordance with some embodiments. In the illustrated example, the scalar processor 202 calculates a recommended scale value 410 by performing a statistical analysis of previously generated results. In the illustrated example, the scalar processor 202 is local to (i.e., part of the same compute unit as) the first vector processor 402, and therefore provides the recommended scale value 410 to the first vector processor 402 by storing the recommended scale value 410 at the shared scale register 206. The scalar processor 202 is not local to the second vector processor 404 or the third vector processor 406, and therefore provides the recommended scale value 410 to the second and third vector processors 404, 406 by storing the recommended scale value 410 at the local memory 145.

The first vector processor 402 provides feedback to the scalar processor 202 by storing a characteristic value 422 of the first portion 412 of the block of data at the feedback register 306. The characteristic value 422 is an absolute maximum value of the elements of the first portion 412 of the block of data in some implementations. In other implementations, the characteristic value 422 is the second highest absolute value of the elements of the first portion 412 of the block of data, or some other metric characterizing the first portion 412 of the block of data, such as the median value or average value. The scalar processor 202 accesses the characteristic value 422 from the feedback register 306 and uses the characteristic value 422 in conjunction with feedback received from the second and third vector processors 404, 406 to calculate an updated recommended scale value 420, as explained in further detail below.

The second vector processor 404 provides feedback to the scalar processor 202 by storing a characteristic value 424 of the second portion 414 of the block of data at the local memory 145. For example, in some implementations, the second vector processor 404 stores the absolute maximum value of the second portion 414 of the block of data at the local memory 145. Similarly, the third vector processor 406 provides feedback to the scalar processor 202 by storing a characteristic value 426 of the third portion 416 of the block of data (e.g., the absolute maximum value of the plurality of values of the third portion 416 of the block of data) at the local memory 145.

In some implementations, the scalar processor 202 accesses the characteristic values 424, 426 provided by the second and third vector processors 404, 406 from the local memory 145. The scalar processor 202 compares the characteristic values 422, 424, 426 of each of the first, second and third portions 412, 414, 416 of the block of data to determine an overall characteristic value of the block of data (e.g., the largest absolute maximum value of the entire block of data). Based on the overall characteristic value of the block of data, the scalar processor 202 calculates an updated recommended scale value 420. For example, in some implementations, the scalar processor 202 performs a statistical analysis of previously generated results as well as the characteristic values 422, 424, 426 to calculate the updated recommended scale value 420.

The scalar processor 202 provides the updated recommended scale value 420 to the first vector processor by storing the updated recommended scale value 420 at the shared scale register 206. The scalar processor 202 provides the updated recommended scale value 420 to the second vector processor 404 and the third vector processor 406 by storing the updated recommended scale value 420 at the local memory 145, which is accessible by both the scalar processor 202 and the second and third vector processors 404, 406. Each of the first vector processor 402, the second vector processor 404, and the third vector processor 406 use the updated recommended scale value 420 to determine a shared scale value (not shown) that they use to quantize their respective portions 412, 414, 416 of the block of data from a wide data type format to a narrow data type format.

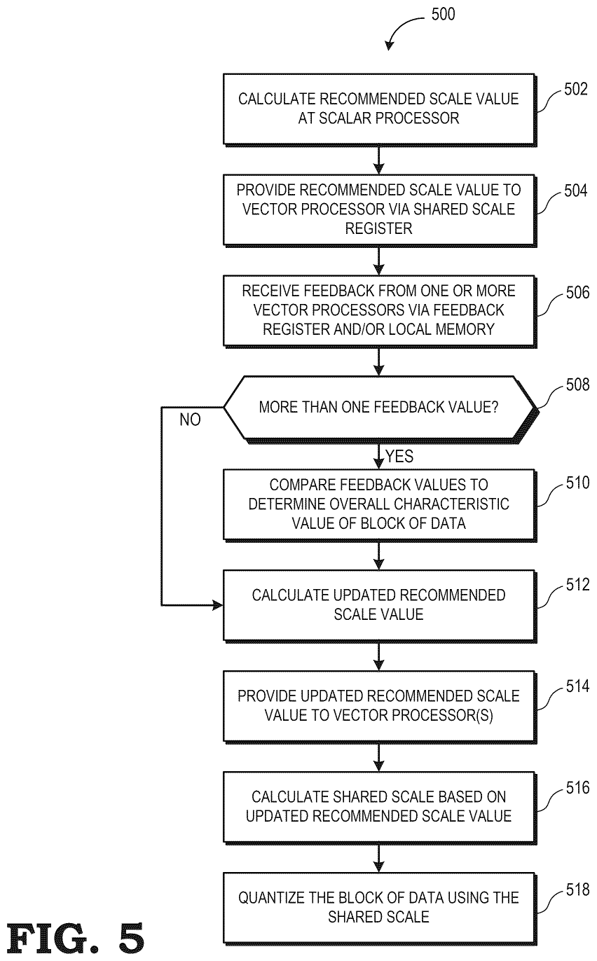

FIG. 5 is a flow diagram illustrating a method 500 for providing a recommended scale from a scalar processor to a vector processor for scaling a block of data in accordance with some embodiments. In some embodiments, the method 500 is implemented in a processing system such as processing system 100.

At block 502, the scalar processor calculates a recommended scale value, such as recommended scale value 210, for a block of data. In some implementations, the scalar processor 202 calculates the recommended scale value 210 based on a statistical analysis of previously generated results. At block 504, the scalar processor 202 stores the recommended scale value 210 at a shared scale register, such as shared register 206, that is accessible by both the scalar processor 202 and a vector processor such as vector processor 204 that stores at least a portion of the block of data at accumulator registers such as accumulator registers 212. In some embodiments, the vector processor 204 accesses the recommended scale value 210 from the shared register 206 and determines a shared scale such as shared scale 208 based on the recommended scale value 210 to use to quantize the at least a portion of the block of data.

In other embodiments, the vector processor 204 provides feedback in the form of a characteristic value of the at least a portion of the block of data to the scalar processor 202 via a feedback register, such as feedback register 306, that is accessible by both the scalar processor 202 and the vector processor 204. In some embodiments, the characteristic value is an absolute maximum value of the at least a portion of the block of data, or some other metric that characterizes the at least a portion of the block of data, such as a next-to-absolute maximum value or a median value of the at least a portion of the block of data.

In some cases, the block of data is distributed among multiple vector processors, such that each vector processor stores a portion of the block of data at its respective accumulator registers. In such cases, each of the multiple vector processors provides feedback in the form of a characteristic value of the portion of the block of data stored at their respective accumulator registers. Whereas the vector processor that is local to the scalar processor 202 (e.g., vector processor 402) provides the characteristic value of its portion of the block of data via the shared feedback register 306, the vector processors that are not local to the scalar processor 202 (e.g., vector processors 404, 406) provide the characteristic values of their respective portions of the block of data to the scalar processor 202 via a local memory, such as local memory 145. At block 506, the scalar processor 202 accesses the characteristic value(s) of the block of data via the shared feedback processor 306 and the local memory 145.

At block 508, the scalar processor 202 determines if more than one characteristic value has been provided for the block of data. If more than one characteristic value has been provided for the block of data, the method flow continues to block 510. At block 510, the scalar processor 202 compares the characteristic values provided for the multiple portions of the block of data and determines an overall characteristic value (e.g., the largest absolute maximum value of the provided characteristic values) for the block of data. The method flow then continues to block 512. If, at block 508, the scalar processor 202 determines that only one characteristic value for the block of data was provided, the method flow continues to block 512.

At block 512, the scalar processor 202 determines an updated recommended scale value for the block of data, such as updated recommended scale value 420. In some embodiments, the scalar processor 202 calculates the updated recommended scale value 420 based on the feedback value(s) and a statistical analysis of previous results. At block 514, the scalar processor 202 provides the updated recommended scale value 420 to the vector processor(s). For example, the scalar processor 202 provides the updated recommended scale value 420 to the local vector processor 402 via the shared register 206, and provides the updated recommended scale value 420 to the non-local vector processor(s) via the local memory 145.

At block 516, the vector processor(s) calculate a shared scale 208 based on the updated recommended scale value 420. At block 518, the vector processor(s) perform an operation on the block of data to quantize the block of data from a wide data type format (e.g., fp32) to a narrow data type format (e.g., fp4) using the shared scale.

In some embodiments, the apparatus and techniques described above are implemented in a system including one or more integrated circuit (IC) devices (also referred to as integrated circuit packages or microchips), such as the processing system described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc.

This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A device, comprising:
a first vector processor comprising hardware configured to scale at least a first portion of a block of data; and
a scalar processor comprising hardware configured to provide a suggested scale value to the first vector processor for scaling the at least a first portion of the block of data from a first data type format to a second data type format, wherein the first data type format is wider than the second data type format.

2. The device of claim 1, further comprising:
a shared register to store the suggested scale value, wherein the shared register is accessible by the first vector processor and the scalar processor.

3. The device of claim 1, wherein the first vector processor is to scale the at least a first portion of the block of data based on the suggested scale value.

4. The device of claim 1, further comprising:
a shared feedback register accessible by the first vector processor and the scalar processor, wherein
the first vector processor is to store a characteristic value of the at least a first portion of the block of data at the shared feedback register.

5. The device of claim 4, wherein the scalar processor is to update the suggested scale value based on the characteristic value of the at least a first portion of the block of data.

6. The device of claim 5, further comprising:
a second vector processor to scale a second portion of the block of data based on the updated suggested scale value.

7. The device of claim 6, wherein the second vector processor is to access the suggested scale value from a local memory.

8. The device of claim 5, wherein the first vector processor is to scale a second portion of the block of data based on the updated suggested scale value.

9. The device of claim 1, wherein the scalar processor is to provide the first vector processor a suggestion for pruning an output of an operation performed by the first vector processor.

10. A method, comprising:
providing, at a scalar processor, a suggested scale value to a first vector processor for scaling a block of data from a first data type format to a second data type format; and
scaling at least a first portion of the block of data at the first vector processor based on the suggested scale value.

11. The method of claim 10, further comprising:
storing the suggested scale value at a shared register, wherein the shared register is accessible by the first vector processor and the scalar processor.

12. The method of claim 10, further comprising:
performing an operation on the scaled at least a first portion of the block of data at the first vector processor.

13. The method of claim 12, further comprising:
providing, at the scalar processor, a suggestion for pruning an output of the operation to the first vector processor.

14. The method of claim 10, further comprising:
storing a characteristic value of the at least a first portion of the block of data at a shared feedback register accessible by the first vector processor and the scalar processor.

15. The method of claim 14, further comprising:
updating, at the scalar processor, the suggested scale value based on the characteristic value of the at least a first portion of the block of data.

16. The method of claim 15, further comprising:
scaling a second portion of the block of data based on the updated suggested scale value at a second vector processor.

17. The method of claim 16, further comprising:
accessing, at the second vector processor, the suggested scale value from a local memory.

18. The method of claim 15, further comprising:
scaling a second portion of the block of data based on the updated suggested scale value at the first vector processor.

19. A compute unit, comprising:
a scalar processor comprising hardware configured to provide a suggested scale value for quantizing a block of data from a first data type format to a second data type format; and
a vector processor comprising hardware configured to quantize at least a portion of the block of data based on the suggested scale value.

20. The compute unit of claim 19, further comprising:
a register accessible by the scalar processor and the vector processor to store the suggested scale value.
